(19) United States
(12) Patent Application Publication
(10) Pub. No.: US 2012/0029789 A1
(43) Pub. Date: Feb. 2, 2012

(54) Methods of detecting pre-ignition and preventing it from causing knock in direct injection spark ignition engines

(75) Inventors: Darius Mehta, San Antonio, TX (US); Terrence F. Alger, II, San Antonio, TX (US); Manfred Amann, San Antonio, TX (US); Jayant V. Sarlashkar, San Antonio, TX (US)

(73) Assignee: Southwest Research Institute, San Antonio, TX (US)

(21) Appl. No.: 13/135,698

(22) Filed: Jul. 12, 2011

Related U.S. Application Data
(63) Continuation-in-part of application No. 12/799,753, filed on Apr. 30, 2010.

(51) Int. Cl. F02P 5/152; G01M 15/04

(52) U.S. Cl. 701/103; 123/406.29

(57) ABSTRACT

A method of preventing a pre-ignition event within a cylinder (20) of a spark ignition engine (100) involves taking in-cylinder measurements and using the measurements to determine the instantaneous heat being released within the cylinder (20) as a function crank angle. If significant heat is being released before the intended spark timing, additional fuel is injected into the cylinder (20) immediately following the detection of early heat release (pre-ignition) within the same engine cycle, preferably within 45 crank angle degrees following the detection of pre-ignition. The additional fuel quenches the heat released within the cylinder (20) to prevent a pre-ignition event.

### TECHNICAL FIELD

Embodiments are generally related to improved automotive engine performance. Embodiments also relate to the field of improved combustion cycles in a spark ignition engine, such as an internal combustion engine. In addition, embodiments relate to preventing a pre-ignition event by detecting unusual heat released within a combustion chamber and quenching the additional heat with more fuel in order to mitigate engine knock.

### BACKGROUND OF THE INVENTION

Pre-ignition in a flame propagation (or “spark-ignition” as the terms will be used interchangeably throughout) engine describes an event wherein the air/fuel mixture in the cylinder ignites before the spark plug fires. Pre-ignition is initiated by an ignition source other than the spark, such as hot spots in the combustion chamber, a spark plug that runs too hot for the application, or carbonaceous deposits in the combustion chamber heated to incandescence by previous engine combustion events.

Many passenger car manufacturers have observed intermittent pre-ignition in their production turbocharged gasoline engines, particularly at low speeds and medium-to-high loads. At these elevated loads, pre-ignition usually results in severe engine knock that can damage the engine. The cause of the pre-ignition is not fully understood, and may in fact be attributed to multiple phenomena such as hot deposits within the combustion chamber, elevated levels of lubricant vapor entering from the PCV system, oil seepage past the turbocharger compressor seals or oil and/or fuel droplet autoignition during the compression stroke.

Pre-ignition can sharply increase combustion chamber temperatures and lead to rough engine operation or loss of performance. Traditional methods of eliminating pre-ignition are available and include proper spark plug selection, proper fuel/air mixture adjustment, and periodic cleaning of the combustion chambers. Such methods, however, do not attempt to predict the occurrence of pre-ignition. A means of detecting the conditions leading up to a pre-ignition event would permit the use of a vehicle's engine management system to adjust one or more engine control parameters in order to mitigate potential upcoming pre-ignition events.

Therefore, a way of determining when conditions are favorable for the occurrence of a pre-ignition event in a modern day spark ignition engine would be advantageous. Furthermore, a means of mitigating the impending undesirable effects of a pre-ignition event once detected would result in better engine performance and improved engine longevity.

### SUMMARY OF THE INVENTION

The present invention provides methods of preventing the premature ignition of an air/fuel mixture within the combustion chamber of a spark ignition engine to mitigate engine knock. According to one embodiment, information from an in-cylinder pressure transducer is used to detect the occurrence of heat release before the intended spark event. This may be performed on all cylinders of the engine on a cycle-by-cycle basis. When premature heat release is detected, additional fuel may be injected into the pre-igniting cylinder immediately thereafter such as, for example, on the same engine cycle just a few crank angle degrees after detection. This has been found to provide both thermal and chemical mechanisms to reduce the heat release rate.

Specifically, as fuel is injected a thermal “charge cooling” effect occurs as heat from the charge is used to evaporate the newly injected liquid fuel. This results in lower overall charge temperature, which reduces the heat release rate. In addition, a chemical “quenching” effect takes place by producing locally fuel-rich regions that are slow to burn. Both of these effects have the result of limiting the heat release after pre-ignition such that the bulk gas temperature is not raised sufficiently to cause knock. Since the pre-ignition heat release rate will be reduced or eliminated, it will be necessary to have a spark ignition event for this same cycle in order to re-establish combustion. Spark timing may be retarded from the nominal value by either a fixed amount or by an amount to be determined based on the magnitude of cumulative heat release that occurred before the intended spark timing (intelligent timing control). This may be necessary, for example, if combustion cannot be re-initiated at the desired spark timing interval.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example spark ignition engine coupled to an engine control module according to one embodiment of the invention;

FIG. 2 is a diagram showing the sequence of the detection, injection, and ignition steps according to one embodiment;

FIG. 3 is a high level block diagram of system for detecting a pre-ignition event and preventing it from causing knock in a direct injection spark ignition engine according to one embodiment.

### DETAILED DESCRIPTION

The particular values and configurations discussed in these non-limiting examples can be varied and are cited merely to illustrate at least one embodiment and are not intended to limit the scope thereof.

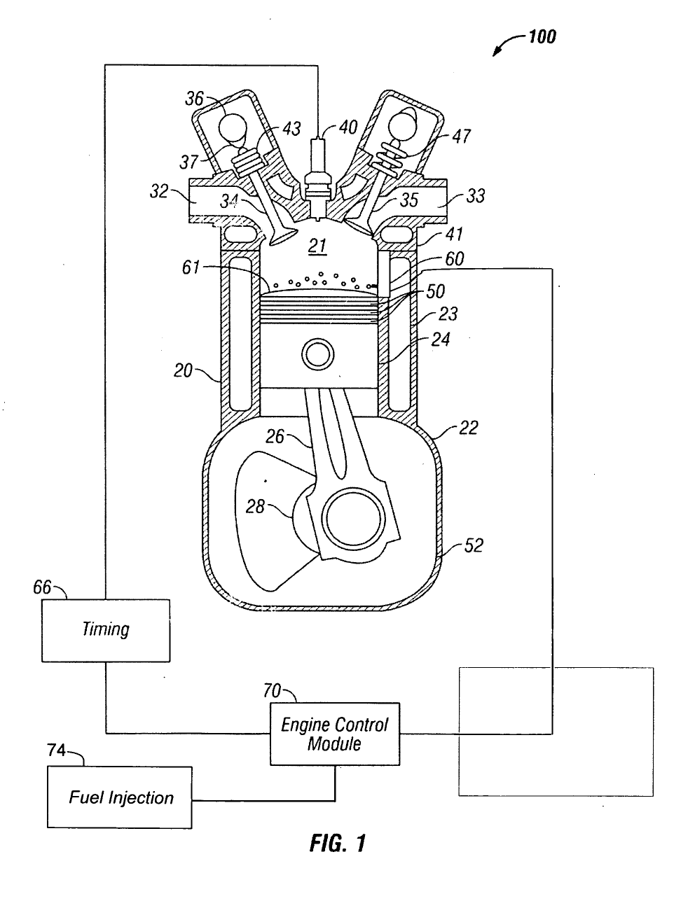

With reference to FIG. 1 a spark ignition engine according to a first embodiment of the invention is shown and denoted generally as 100. Engine 100 includes a cylinder 20 coupled to crankcase 22. A piston 24 travels up and down within the combustion chamber 21 of cylinder 20 and is connected to a crankshaft 28 via a piston rod 26. The cylinder 20 is attached to the crankcase 22 which houses the crankshaft 28. The underside of the piston 24 and the crankcase 22 forms a crankcase volume that will vary as the piston 24 moves up and down within the combustion chamber 21.

Engine 100 is supplied an air/fuel mixture through intake passageway 32. The air/fuel mixture is supplied to the combustion chamber 21 by the operation of intake valve 34 which, in turn, is opened and closed by the rotation of camshaft 36 and cam 37. A spark plug 40 provides the energy necessary to ignite the air/fuel mixture which combusts inside the combustion chamber 21 causing piston 24 to move downward in the direction of crankcase 22 resulting in the rotation of crankshaft 28. Combustion creates exhaust vapors which exit through exhaust valve 35 of engine 100 via exhaust passageway 33. Valves 34 and 35, passageways 32 and 33, and spark plug 40 are typically part of the upper portion of a 4 cycle internal combustion engine, such as engine 100, commonly referred to as the head 41.

A specified amount of engine lubricant 52 is typically maintained in a portion of the volume defined by crankcase 22. A set of piston rings 50 are used to seal the combustion chamber 21 from the crankcase 22, to support heat transfer from the piston 24 to the walls of the cylinder 20, and to regulate the consumption of engine lubricant 52. Passage 23 provides a path for coolant to travel for the extraction of engine heat.

Engine 100 is an example of a typical spark ignition internal combustion engine platform widely used by car manufacturers in many passenger cars. Such engines are known to suffer from intermittent pre-ignition, particularly at low speeds and at medium-to-high loads. At these elevated loads, pre-ignition usually results in severe engine knock. While the cause of the pre-ignition is not fully understood, the inventors of the current invention suspect it may be attributed to multiple phenomena such as hot deposits within the combustion chamber, elevated levels of lubricant vapor entering from the PCV system, oil seepage past the turbocharger compressor seals or oil and/or fuel droplet autoignition during the compression stroke.

The present invention provides methods of preventing the premature ignition of an air/fuel mixture to eliminate or reduce engine knock, which is the most important situation to avoid. Specifically, the inventors of the present invention have discovered engine knock can be eliminated or reduced substantially by injecting additional fuel into the combustion chamber 21 once the onset of a pre-ignition event has been detected. To detect the onset of pre-ignition an in-cylinder pressure transducer 60 can be used to detect the occurrence of heat release before the intended spark event. This can be performed on all cylinders of the engine 100 and on a cycle-by-cycle basis. When premature heat release is detected, additional fuel can be injected into the pre-igniting cylinder immediately thereafter (i.e., on the same engine cycle, just a few crank angle degrees after detection) to provide both thermal and chemical mechanisms to reduce the heat release rate.

Thus, in one embodiment, an in-cylinder pressure transducer 60 is utilized to make pressure measurements within the combustion chamber 21. Preferably, pressure transducer 60 is used to detect the occurrence of heat release before the intended spark event. Thus, transducer 60 can be utilized to calculate a heat release rate in order to determine if more than the expected amount of heat is being released within the combustion chamber 21 prior to a spark event cycle. By calculating heat release rates it is possible to detect pre-ignition. Alternatively, pressure transducer 60 can be used to calculate if there has been a departure from an average pressure trace in a given angle window which would also be indicative of a pre-ignition event.

When premature heat release is detected as indicated by the output form pressure transducer 60, the engine control module 70 can cause fuel injection module 74 to inject additional fuel into the combustion chamber 21 of the cylinder 20 prior to a pre-ignition event, i.e. on the same engine cycle, just a few crank angle degrees after heat detection. The fact that fuel injection module 74 injects additional fuel into combustion chamber 21 after detecting heat release within the combustion chamber 21 provides both thermal and chemical mechanisms to reduce the heat release rate within the combustion chamber 21. Thus, as fuel is injected, a thermal “charge cooling” effect occurs as heat from the charge is used to evaporate the newly injected liquid fuel. It has been found that this results in lower overall charge temperature, which reduces the heat release rate. In addition, a chemical “quenching” effect takes place by producing locally fuel-rich regions that are slow to burn. Both of these effects have the result of limiting the heat release after pre-ignition such that the bulk gas temperature is not raised sufficiently to cause knock.

Since the pre-ignition heat release rate will be reduced or eliminated, it may be necessary to have a spark ignition event for this same cycle in order to re-establish combustion. Thus, engine control module 70 can cause the spark timing module 66 to retard spark timing from the nominal value by either a fixed amount or by an amount to be determined based on the magnitude of cumulative heat release that occurred before the intended spark timing. Alternatively, the conventional timing could be maintained as long as the air/fuel mixture can be successfully re-ignited at the original spark timing. The operation of engine control module 70 and timing module 66 provide a form of intelligent timing control.

As would be understood by those of ordinary skill in the art, the engine control system 70 can implement various engine performance control strategies to mitigate a pre-ignition event. Such strategies could include, but are not limited to, modifying (increasing or decreasing) the amount of fuel injected into the combustion chamber 21 via, for example, fuel injection system 74. Alternatively, engine control module 70 can temporarily reduce engine load by closing the throttle, reducing boost pressures, or altering combustion timing. Other methods of countering a pre-ignition event may be employed as will become apparent to those of ordinary skill in the art.

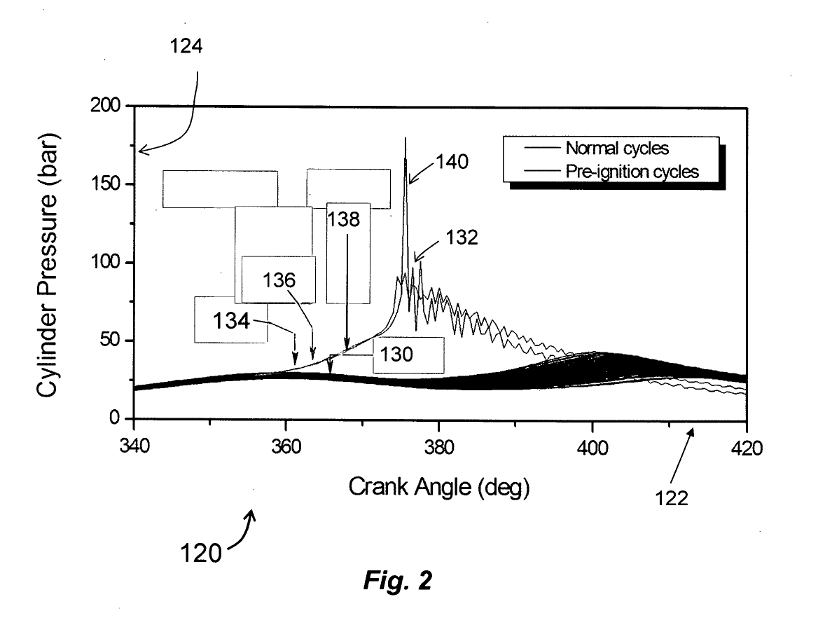

Referring to FIG. 2, a diagram showing the sequence of the detection, injection, and ignition steps is provided and denoted generally as 120. Axis 122 represents the crank angle in degrees while cylinder pressure is indicated along axis 124. Trace 130 represents the normal spark timing curve and is provided as a reference line which, when compared to trace 132, can be used to demonstrate the occurrence of a pre-ignition cycle. Specifically, at point 134 the beginning of a pre-ignition event is detected. This can be accomplished by sensing an increase in the amount of heat being released, as explained above. Alternatively, in-cylinder pressure measurements can be used to determine if there has been pressure variations as compared to “normal” compression pressure. Such pressure variations at the end of a compression stroke would also be indicative of a pre-ignition event. Next, at point 136, a knock suppression injection step can occur by injecting additional fuel into the combustion chamber of a spark ignition engine, such as engine 100 followed by a modification of normal spark timing as indicated at point 138.

It should be noted that the timing of the injection event relative to the spark event could be different than shown in the diagram 120. For example, the spark event may occur before, during, or after the injection event and still produce the desired effect. Also, if the approach were to be implemented on the pre-igniting engine data shown in diagram 120, it is expected that the rapid pressure increase due to knock near 373 crank angle degrees (point 140) would be reduced, and the subsequent high frequency pressure oscillations would be eliminated.

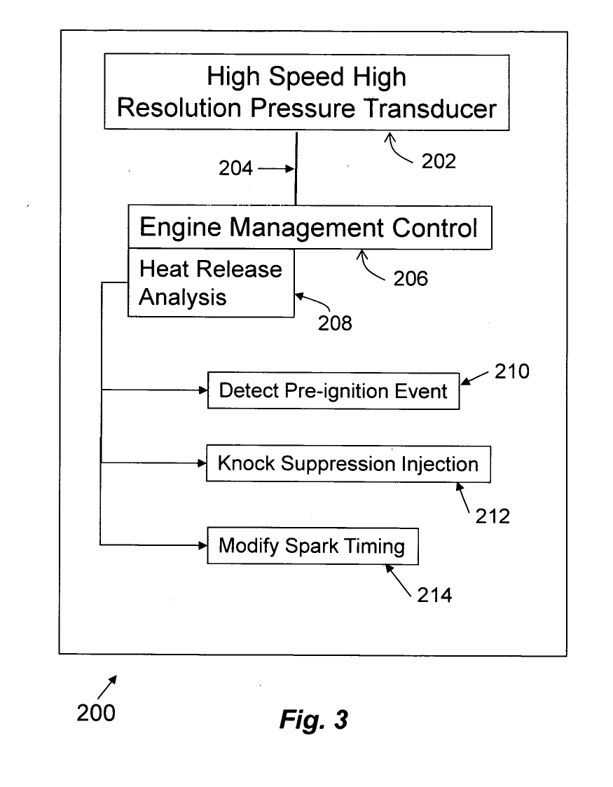

FIG. 3 is a high level block diagram of a system 200 for detecting a pre-ignition event and preventing it from causing knock in a direction injection spark ignition engine according to one embodiment of the invention is shown. System 200 is shown to include a high speed high resolution pressure transducer 202. Such pressure sensors are already used in production applications, for example the 2009 Volkswagen Jetta TDI. In general, when selecting a suitable transducer it is important to look for a sensor with a response time faster than the frequency of the pressure wave caused heat energy released within the combustion chamber. Since this frequency varies from engine to engine based on engine size and design, the sensor selection and calibration would ideally be matched to the particular engine.

As shown, pressure transducer 202 is coupled to engine management control module 206 via signal pathway 204. Preferably, control module 206 comprises the hardware and software required to diagnose and adjust various engine conditions such as, for example, the ability to analyze the heat being released within the combustion chamber of a spark ignition engine, as represented by block 208. Control module 206 could be readily implemented as part of a vehicle's onboard computer which is commonly employed in modern day automobiles. Thus, the implementation of the control module 206 according to the invention can be readily incorporated into modern automotive designs.

In one embodiment, control module 206 includes a set of software coded instructions 210, 212, 214 in which the functions of a system detecting a pre-ignition event and preventing it from causing knock in a direct injection spark ignition engine can be implemented. For example, software coded instructions 210 could be written and stored in the module 206 in order to analyze heat release information and detect when a pre-ignition event has occurred. This is facilitated by the operation of pressure transducer 202 to allow the module 206 to determine if unusual amounts of heat release are being detected in the combustion chamber.

Likewise, when abnormal rates of heat release are detected, control module 206 can cause additional fuel to be injected into the combustion chamber as a means of quenching the additional heat release and preventing the undesirable after effects of a pre-ignition event, as represented by block 212. Finally, due to the additional fuel, it may be necessary to modify the normal spark timing, as represented by block 214.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of preventing a pre-ignition event in a spark ignition engine comprising the steps of:
taking at least one in-cylinder engine measurement within a first cylinder of said engine;
using the in-cylinder engine measurement to determine the instantaneous heat release rate within said first cylinder before a spark timing cycle; and
if significant heat release is detected, an engine management system injecting additional fuel into said first cylinder during the same engine cycle.
wherein the additional fuel quenches the heat release within said first cylinder to prevent a pre-ignition event.

2. The method of claim 1 wherein said in-cylinder measurement comprises taking a pressure measurement within said first cylinder.

3. The method of claim 1 wherein said in-cylinder measurement comprises taking an ion sensing measurement within said first cylinder.

4. The method of claim 1 further comprising the step of retarding the spark timing of said spark timing cycle by an amount that ensures re-ignition of the fuel/air mixture within said cylinder.

5. The method of claim 4 wherein said spark timing is retarded a fixed amount.

6. The method of claim 4 wherein said spark timing is retarded an amount determined based on the magnitude of cumulative heat released within said first cylinder.

7. The method of claim 1 wherein said step of taking at least one in-cylinder measurement comprises taking a pressure measurement within said first cylinder and further comprising the step of determining if cylinder pressure is higher than a predetermined threshold value at one or more crank angle positions.

8. The method of claim 7 further comprising the step of basing the amount of spark retard on the amount of cylinder pressure over said predetermined threshold value.

9. The method of claim 1 wherein said step of injecting additional fuel into said first cylinder comprises the step of injecting additional fuel into multiple closely spaced injections.

10. The method of claim 1 wherein said step of taking at least one in-cylinder engine measurement comprises sensing ions within said cylinder.

11. A method of preventing a pre-ignition event within a cylinder of a spark ignition engine comprising the steps of
taking in-cylinder measurements within said cylinder of said engine;
using the in-cylinder engine measurements to determine the instantaneous heat being released within said cylinder as a function each crank angle; and
if significant heat is being released before the intended spark timing, injecting additional fuel into said cylinder within 45 crank angle degrees following the detection of pre-ignition.
wherein the additional fuel quenches the heat release within said cylinder to prevent a pre-ignition event.

12. The method of claim 11 wherein said step of taking in-cylinder measurements comprises taking pressure measurements.

13. The method of claim 11 wherein said step of taking in-cylinder measurements comprises sensing ions within said cylinder.

14. The method of claim 11 further comprising the step of retarding the spark timing of the next engine cycle if necessary to re-ignite the fuel/air mixture within the cylinder.

15. The method of claim 14 wherein said spark timing is retarded a fixed amount.

16. The method of claim 14 wherein said spark timing is retarded an amount determined based on the magnitude of cumulative heat released within said cylinder.

17. The method of claim 14 wherein said step of taking in-cylinder measurements comprises taking a pressure measurement within said cylinder and further comprising the step of determining if cylinder pressure is higher than a predetermined threshold value at one or more crank angle positions.

18. The method of claim 17 further comprising the step of basing the amount of spark retard on the amount of cylinder pressure over said predetermined threshold value.
